(19) United States
(12) Patent Application Publication
(10) Pub. No.: US 2026/0067083 A1
(43) Pub. Date: Mar. 5, 2026

(54) SECURE TOKEN EXCHANGE FOR AUTOMATED SYSTEMS

(71) Applicant: INTERNATIONAL BUSINESS MACHINES CORPORATION, ARMONK, NY (US)

(72) Inventors: THOMAS DÜRR, MAGSTADT (DE); MARTIN SMOLNY, BOEBLINGEN (DE); MICHAEL BECK, BAD TEINACH-ZAVELSTEIN (DE); CHRISTOPHER HATKO, GATINEAU (CA)

(21) Appl. No.: 18/820,932

(22) Filed: Aug. 30, 2024

(51) Int. Cl. H04L 9/32; H04L 9/40

(52) U.S. Cl. CPC H04L 9/3213; H04L 63/0435

(57) ABSTRACT

Secure token exchange for automated systems includes receiving, for validation, an application programming interface (API) token grant request, including an API key, sent by an automated system, and retrieving, from a database, an API key entity corresponding to the API key, wherein the API key entity includes a token receive endpoint. An authentication token is generated. The authentication token is asynchronously pushed to the token receive endpoint for access by the automated system.

### BACKGROUND

The present disclosure relates to methods, apparatus, and products for secure token exchange for automated systems.

### SUMMARY

According to embodiments of the present disclosure, various methods, apparatus and products for secure token exchange for automated systems are described herein. In some aspects, secure token exchange for automated systems includes receiving, for validation, an application programming interface (API) token grant request, including an API key, sent by an automated system, and retrieving, from a database, an API key entity corresponding to the API key, wherein the API key entity includes a token receive endpoint. An authentication token is generated. The authentication token is asynchronously pushed to the token receive endpoint for access by the automated system.

### BRIEF DESCRIPTION OF THE DRAWINGS

FIG. 1 sets forth an example computing environment according to aspects of the present disclosure.

FIG. 2 sets forth an example system for secure token exchange for automated systems according to aspects of the present disclosure.

FIG. 3 sets forth interactions related to registration of a token receive endpoint in a system for secure token exchange for automated systems according to aspects of the present disclosure.

FIG. 4 sets forth interactions related to secure token exchange with encryption in a system for secure token exchange for automated systems according to aspects of the present disclosure.

FIG. 5 sets forth interactions related to preventing an impostor from acquiring access to a token in a system for secure token exchange for automated systems according to aspects of the present disclosure.

FIG. 6 sets forth interactions related to secure token exchange without encryption involving two automated systems in a system for secure token exchange for automated systems according to aspects of the present disclosure.

FIG. 7 sets forth interactions related to secure token exchange with an annotated endpoint in a system for secure token exchange for automated systems according to aspects of the present disclosure.

FIG. 8 sets forth a flowchart of an example method for secure token exchange for automated systems according to aspects of the present disclosure.

### DETAILED DESCRIPTION

Identity and access management (IAM) is a framework of processes, policies, and technologies that facilitates the management of digital identities. An IAM framework can control access to protected resources (e.g., data, documents, files, software, hardware, services, and the like) corresponding to an entity, such as, for example, an enterprise, business, company, organization, institution, agency, or the like. IAM systems can be deployed on premises, provided by a third-party vendor through a cloud-based subscription model, or deployed in a hybrid model. Typical systems used for IAM include single sign-on systems, two-factor authentication, multifactor authentication, privileged access management, and token-based authorization.

Token-based authentication is a protocol which allows end users and services to verify their identity and in return receive a unique authentication token. During the lifetime of a token (e.g., a defined period of time), end users and services can access a protected resource, such as a cloud service, for which the token has been issued. First, an end user or service requests access to the protected resource. An authorization server (e.g., identity provider) determines whether the end user or service should have access by, for example, comparing the received credentials with stored credentials corresponding to the end user or service. After credential authentication or verification, the authorization server issues the token to the end user or service.

Before a particular client web application of the end user or service can access a particular protected resource using an application programming interface (API), the client web application obtains the token that grants access to that particular API. The token may contain an end user or service identifier for the network session and may identify protected resource access privileges using scopes. A scope is a space-separated list of resource access permissions that the client web application is given permission to access. In other words, a scope determines the type of access that the access token does and does not permit.

Authentication methods in cloud identity providers may rely on symmetric credential exchanges for automated system authentication. An identity provider is a system that creates, maintains, and manages identity information for principals while providing authentication services to relying party (client) applications within a federating identity system. An identity provider may be configured to provide authentication services via at least one validation method (or validation protocol or authentication protocol). An identity provider may use the same or different validation methods for different users.

An example credential that may be used by an identity provider is an API key that may be traded for a temporary token (e.g., a JavaScript Object Notation (JSON) web token (JWT)) during long running processing. An API key is a code without which access to the API is not allowed (i.e., the API is secured by the API key). Hence, a service initiated by access to the API will not be executed without providing the correct API key together with other parameters required for the API. A JWT can include a header, a payload, and a signature. The header contains metadata about the type of token being used and the cryptographic algorithms used to secure its contents. The payload can include a set of claims, which are statements about the permissions that should be allowed. The signature can be used to validate the token is trustworthy and to help ensure that they have not been tampered with. There are two major ways to obtain such tokens: (1) Browser-centric components may use Open Authorization (OAuth) or OpenID Connect (OIDC) flows against the cloud identity provider to obtain such tokens; and (2) Automated or Command Line Interface (CLI) based components may obtain such tokens via exchanging API keys into a token by calling a Representation State Transfer (REST) endpoint on the cloud identity provider.

Cloud systems may use JWT authentication to interact with each other. However, this method introduces risks. A potential issue with an API key is that it is a shared credential that has risk to be leaked or exposed. If an API key is compromised, it can lead to extensive impersonation attacks. The attacker can continuously exchange the API key for temporary tokens, enabling the attacker to impersonate the targeted identity (e.g., an automated service) indefinitely with many potential consequences (e.g., leaked confidential information, malicious workload, compromised infrastructure, etc.).

An example curl for such a token exchange is given in the following Pseudocode Example I:

### Pseudocode Example I

curl -H “Content-Type: application/x-www-form-urlencoded”\
   --data-urlencode “grant_type=apikey”\
   --data-urlencode “apikey=$APIKEY”\
   “https://iam.cloud.ibm.com/identity/token”

Some examples disclosed herein are directed to a system and method for secure token exchange on automated systems. In some examples, the identity provider introduces an asymmetric requirement to the credential exchange. In some examples, the token exchange includes two steps where an attacker not only needs knowledge of the API key, but also access to the system that asynchronously receives the requested token. In some examples, instead of directly returning a token for an API key exchange, the identity provider accepts the token exchange request from the automated system but does not return the token itself to the automated system in the response. In some examples, the identity provider generates the token, encrypts the token, and pushes the encrypted token to a pre-registered endpoint that is associated with the API key. The used encryption key is provided in response to the API key token grant request. The respective endpoint is owned or accessible by the automated system, so that the system can consume the token and decrypt it with the encryption key it received by the original API key grant.

In some examples, an automated system sends an API key token grant request to an identity provider. The identity provider validates the API key and fetches the respective entity stored in its database. In some examples, a token receive endpoint is present on the entity, and is established as part of a registration process. The identity provider generates the authentication token (e.g., containing a JWT ID (JTI) claim unique to the token). The identity provider generates a new encryption key and symmetrical encrypts the token with the generated encryption key. The identity provider finishes the request transaction by sending a response to the automated service that includes the encryption key and the token JTI. The identity provider pushes the encrypted token and the JTI asynchronously from the previous interaction to the token receive endpoint associated with the API key. The automated service receives the encrypted token on the token receive endpoint. The automated service decrypts the token with the encryption key that was provided in response to the token grant request. The automated service can associate the right encryption key by matching the JTI.

Some examples disclosed herein are directed to a push-model based token exchange for automated systems that splits up the API key token exchange from a single synchronous request into an asynchronous approach consisting of the request and an asynchronous delivery of the token. The asynchronous delivery of the token helps to ensure that the token can only be used by a predefined system, addressed via a system callable endpoint. Additionally, the encryption of the token helps to ensure that the receiver also needs to be the requestor of the token. Having access to a shared credential is not sufficient to exchange tokens for it. The resulting token is only available on the pre-registered endpoint of the automated service itself. The encryption further helps to ensure that only the system that triggered the API key grant can read the token received on the service endpoint. This means that, in order to obtain a usable token, an attacker would need to know the API key, know how to bypass any relevant IP/TOTP (Time-based one-time password) protections on the API key exchange, and would need to compromise the system that receives the encrypted token.

Another approach for addressing issues disclosed herein would be to send a one-time pad (OTP) together with the API key, and Internet Protocol (IP) restrictions may be applied on the API key request. However, the OTP will only protect against retry attacks. In order to keep the automated system able to act without human interaction, the OTP needs to be based on a shared-credential approach, like TOTP. The shared secret to generate the OTP may be subject to leak, like the API key itself, which could lead to a successful attack vector. In addition, the supported IPs of the automated system would need to be synchronized to the identity provider. An un-synced state may lead to failing token exchanges. Automated systems could also be hidden behind gateways, preventing proper IP determination on the identity provider side. Further, with knowledge of the allowed IPs for an API key, an attacker could emulate the IP in the REST request and bypass the IP restriction. Examples disclosed herein prevent attackers from being able to successfully gain tokens by leaked credentials, and since, in some examples, the API grant is decoupled from the actual token, leaked knowledge (e.g., credentials, secrets, IP allowlists) will not enable an attacker to successfully obtain tokens. Examples disclosed herein address the issue of leaked API keys by removing the approach of an API key secret (or any shared secret) being enough to obtain an authentication token.

An example of the present disclosure is directed to a method for secure token exchange for automated systems. The method includes receiving, for validation, an application programming interface (API) token grant request, including an API key, sent by an automated system. The method includes retrieving, from a database, an API key entity corresponding to the API key, where the API key entity includes a token receive endpoint. The method includes generating an authentication token. The method includes asynchronously pushing the authentication token to the token receive endpoint for access by the automated system.

Examples of the method include various technical features that yield technical effects that provide various improvements to computer technology. For instance, some examples include the technical features of retrieving, from a database, an API key entity corresponding to the API key, where the API key entity includes a token receive endpoint; generating an authentication token; and asynchronously pushing the authentication token to the token receive endpoint for access by the automated system. These technical features yield the technical effect of preventing attackers from being able to successfully gain tokens by leaked credentials. Examples disclosed herein are directed to a push-model based token exchange for automated systems that splits up the API key token exchange from a single synchronous request into an asynchronous approach consisting of the request and an asynchronous delivery of the token. The asynchronous delivery of the token helps to ensure that the token can only be used by a predefined system, addressed via a system callable endpoint.

In some examples of the method, the authentication token includes a unique identifier. In some examples, the authentication token is a JavaScript Object Notation (JSON) web token (JWT), and the unique identifier is a JWT ID (JTI) claim of the JWT.

In some examples, the method further includes sending a response to the automated system, where the response includes the unique identifier. In some examples, the method further includes generating an encryption key; and symmetrically encrypting the authentication token with the encryption key to generate an encrypted authentication token, and where the authentication token that is asynchronously pushed to the token receive endpoint includes the encrypted authentication token. In some examples, the method further includes sending a response to the automated system, where the response includes the unique identifier and the encryption key.

In some examples of the method, the token receive endpoint provides access to the automated system to retrieve the encrypted authentication token and decrypt the encrypted authentication token using the encryption key included in the response. In some examples, the token receive endpoint is annotated with a protocol for asynchronously pushing the authentication token.

Another example of the present disclosure is directed to an apparatus for secure token exchange for automated systems. The apparatus includes a processing device. The apparatus includes a memory operatively coupled to the processing device, where the memory stores computer program instructions that, when executed, cause the processing device to receive, for validation, an application programming interface (API) token grant request, including an API key, sent by an automated system. The memory stores computer program instructions that, when executed, cause the processing device to retrieve, from a database, an API key entity corresponding to the API key, where the API key entity includes a token receive endpoint. The memory stores computer program instructions that, when executed, cause the processing device to generate an authentication token. The memory stores computer program instructions that, when executed, cause the processing device to asynchronously push the authentication token to the token receive endpoint for access by the automated system.

Examples of the apparatus include various technical features that yield technical effects that provide various improvements to computer technology. For instance, some examples include the technical features of retrieve, from a database, an API key entity corresponding to the API key, where the API key entity includes a token receive endpoint; generate an authentication token; and asynchronously push the authentication token to the token receive endpoint for access by the automated system. These technical features yield the technical effect of preventing attackers from being able to successfully gain tokens by leaked credentials. Examples disclosed herein are directed to a push-model based token exchange for automated systems that splits up the API key token exchange from a single synchronous request into an asynchronous approach consisting of the request and an asynchronous delivery of the token. The asynchronous delivery of the token helps to ensure that the token can only be used by a predefined system, addressed via a system callable endpoint.

In some examples of the apparatus, the authentication token includes a unique identifier. In some examples, the memory stores computer program instructions that, when executed, further cause the processing device to send a response to the automated system, where the response includes the unique identifier.

In some examples of the apparatus, the memory stores computer program instructions that, when executed, further cause the processing device to: generate an encryption key; and symmetrically encrypt the authentication token with the encryption key to generate an encrypted authentication token, and where the authentication token that is asynchronously pushed to the token receive endpoint includes the encrypted authentication token. In some examples, the memory stores computer program instructions that, when executed, further cause the processing device to send a response to the automated system, where the response includes the unique identifier and the encryption key.

In some examples of the apparatus, the token receive endpoint provides access to the automated system to retrieve the encrypted authentication token and decrypt the encrypted authentication token using the encryption key included in the response. In some examples, the token receive endpoint is annotated with a protocol for asynchronously pushing the authentication token.

Another example of the present disclosure is directed to a computer program product including a computer readable storage medium, where the computer readable storage medium includes computer program instructions that, when executed, receive, for validation, an application programming interface (API) token grant request, including an API key, sent by an automated system. The computer readable storage medium includes computer program instructions that, when executed, retrieve, from a database, an API key entity corresponding to the API key, where the API key entity includes a token receive endpoint. The computer readable storage medium includes computer program instructions that, when executed, generate an authentication token. The computer readable storage medium includes computer program instructions that, when executed, asynchronously push the authentication token to the token receive endpoint for access by the automated system.

Examples of the computer program product include various technical features that yield technical effects that provide various improvements to computer technology. For instance, some examples include the technical features of retrieve, from a database, an API key entity corresponding to the API key, where the API key entity includes a token receive endpoint; generate an authentication token; and asynchronously push the authentication token to the token receive endpoint for access by the automated system. These technical features yield the technical effect of preventing attackers from being able to successfully gain tokens by leaked credentials. Examples disclosed herein are directed to a push-model based token exchange for automated systems that splits up the API key token exchange from a single synchronous request into an asynchronous approach consisting of the request and an asynchronous delivery of the token. The asynchronous delivery of the token helps to ensure that the token can only be used by a predefined system, addressed via a system callable endpoint.

In some examples of the computer program product, the authentication token includes a unique identifier. In some examples, the computer readable storage medium includes computer program instructions that, when executed send a response to the automated system, where the response includes the unique identifier.

In some examples of the computer program product, the computer readable storage medium includes computer program instructions that, when executed: generate an encryption key; and symmetrically encrypt the authentication token with the encryption key to generate an encrypted authentication token, and where the authentication token that is asynchronously pushed to the token receive endpoint includes the encrypted authentication token. In some examples, the computer readable storage medium includes computer program instructions that, when executed, send a response to the automated system, where the response includes the unique identifier and the encryption key.

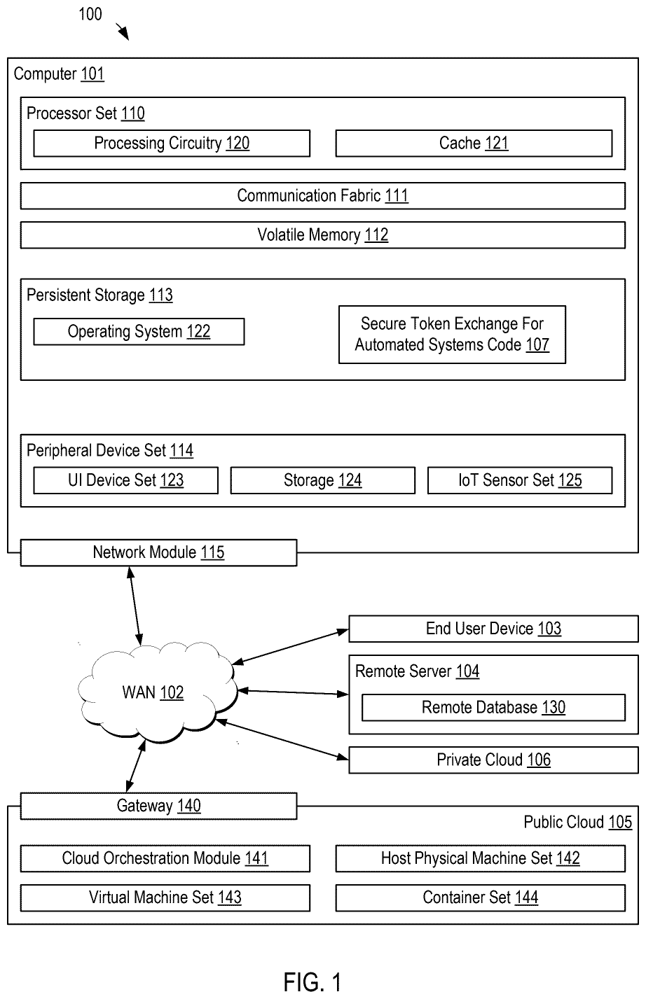

FIG. 1 sets forth an example computing environment according to aspects of the present disclosure. Computing environment 100 contains an example of an environment for the execution of at least some of the computer code involved in performing the various methods described herein, such as secure token exchange for automated systems code 107. In addition to secure token exchange for automated systems code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and secure token exchange for automated systems code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in secure token exchange for automated systems code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in secure token exchange for automated systems code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

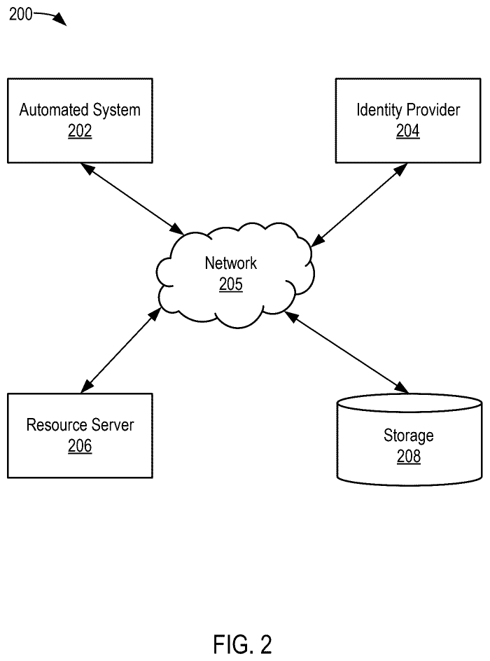

FIG. 2 sets forth an example system 200 for secure token exchange for automated systems according to aspects of the present disclosure. System 200 includes automated system 202, identity provider 204, resource server 206, and storage 208, which are all communicatively coupled together via network 205. The elements of system 200 may perform functions described herein using secure token exchange for automated systems code 107 (FIG. 1). Network 205 may include connections, such as, for example, wire communication links, wireless communication links, fiber optic cables, and the like. Automated system 202 may implement an automated service and may also be referred to herein as an automated service. Identity provider 204 and resource server 206 may be, for example, server computers with high-speed connections to network 205. Identity provider 204 and resource server 206 may each represent multiple computing nodes in one or more cloud environments managed by one or more entities. Identity provider 204 and resource server 206 may each represent one or more clusters of servers in one or more data centers.

Storage 208 may be a network storage device capable of storing any type of data in a structured format or an unstructured format. In addition, storage 208 may represent a plurality of network storage devices. Further, storage 208 may store identifiers and network addresses for a plurality of resource servers, identifiers and network addresses for a plurality of different client devices, identifiers for a plurality of different users, and the like. Furthermore, storage 208 may store other types of data, such as authentication or credential data that may include usernames, passwords, and biometric data associated with the different users, for example.

Resource server 206 may host a set of protected resources. The set of protected resources may include, for example, one or more of data, documents, files, software, hardware, services, and the like. In some examples, system 200 may enable controlled access to data stored in the resource server 206, which may accept and respond to protected resource access requests using authentication tokens. The tokens may contain end user or service identifiers for network sessions and identify protected resource access privileges using scopes. The automated system 202 may interact with the identity provider 204 to retrieve an authentication token. The automated system 202 may pass the authentication token to the resource server 206 (e.g., via an API call to execute an action or retrieve data from the resource server 206).

The identity provider 204 may issue authentication tokens to the automated system 202 after successfully authenticating the automated system 202 and obtaining authorization. The identity provider 204 may issue authentication tokens accepted by multiple resource servers other than the resource server 206. The identity provider 204 may authenticate and authorize the automated system 202, as well as other systems. In some examples, the identity provider 204 validates users'identities, such as the identity of automated system 202, using one or more validation methods or protocols.

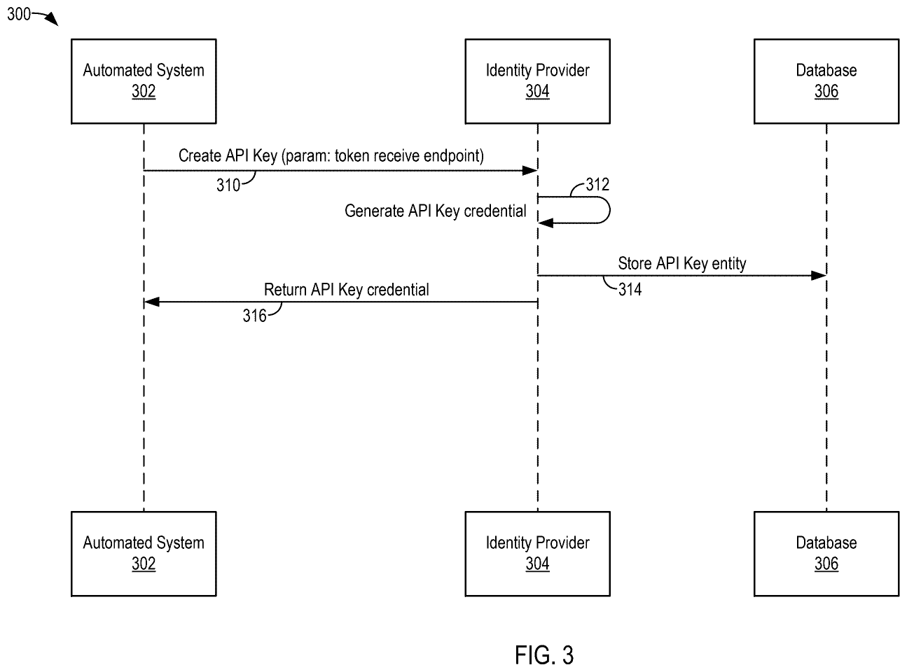

FIG. 3 sets forth interactions 300 related to registration of a token receive endpoint in a system for secure token exchange for automated systems according to aspects of the present disclosure. In some examples, interactions 300 may be performed by system 200 (FIG. 2) using secure token exchange for automated systems code 107 (FIG. 1). In the illustrated example, the interactions 300 are between an automated system 302, an identity provider 304, and a database 306. Automated system 302 is an example of automated system 202 in system 200. Identity provider 304 is an example of identity provider 204 in system 200. Database 306 is an example of storage 208 in system 200. Interactions 300 set forth a one-time registration step in which the owner of an automated service (e.g., automated system 302) registers an API key with a token receive endpoint on the identity provider 304.

At 310 in interactions 300, automated system 302 sends a request to identity provider 304 to create an API key and includes a parameter identifying a token receive endpoint. At 312, identity provider 304 generates, responsive to the request at 310, an API key credential. At 314, identity provider 304 stores an API key entity, including the specified token receive endpoint, in database 306. At 316, identity provider 304 returns a response to the automated system 302 and includes the API key credential.

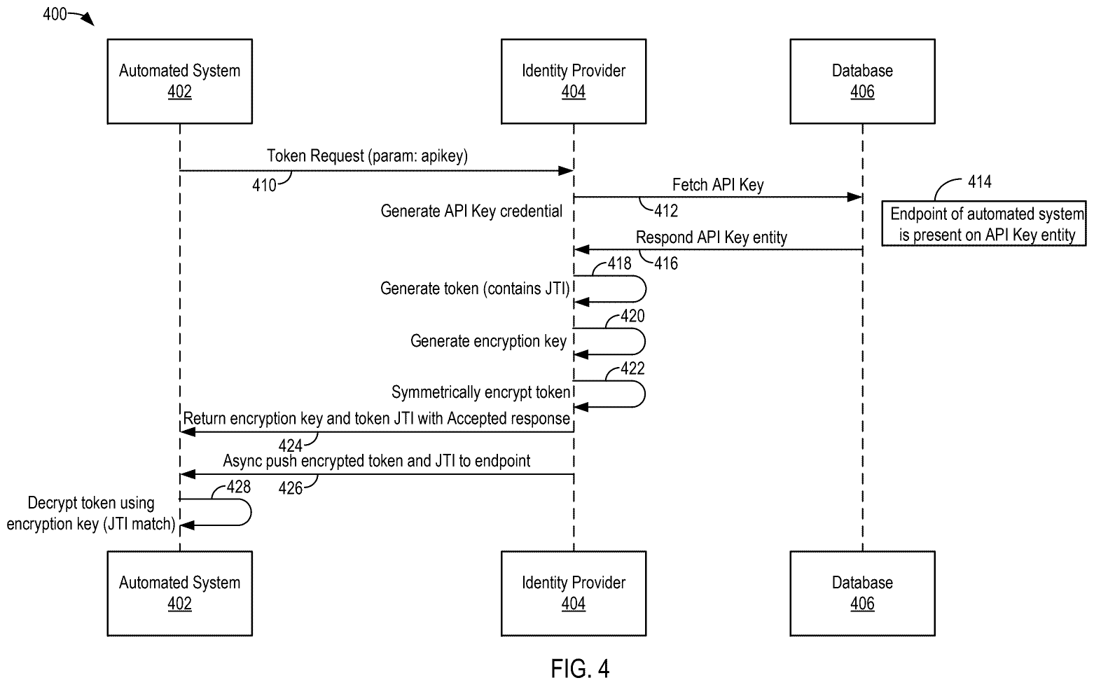

FIG. 4 sets forth interactions 400 related to secure token exchange with encryption in a system for secure token exchange for automated systems according to aspects of the present disclosure. In some examples, interactions 400 may be performed by system 200 (FIG. 2) using secure token exchange for automated systems code 107 (FIG. 1). In the illustrated example, the interactions 400 are between an automated system 402, an identity provider 404, and a database 406. Automated system 402 is an example of automated system 202 in system 200. Identity provider 404 is an example of identity provider 204 in system 200. Database 406 is an example of storage 208 in system 200. Interactions 400 set forth an example authentication including a secure API key token exchange.

At 410 in interactions 400, automated system 402 sends an API key token grant request to identity provider 404 that includes a parameter identifying an API key. At 412, the identity provider 404 validates the API key and fetches the corresponding API key entity stored in its database 406. As indicated at 414, the token receive endpoint associated with the automated system 402 is present on the API key entity, which may be established during registration. At 416, the database 406 provides the API key entity to the identity provider 404. At 418, the identity provider 404 generates the authentication token, which contains a JTI claim unique to the token. At 420, the identity provider 404 generates a new encryption key. At 422, the identity provider 404 symmetrical encrypts the authentication token with the encryption key generated at 420. At 424, the identity provider 404 sends a response to the automated system 402 including the encryption key generated at 420 and the token JTI and an “accepted” indication, thereby finishing the request transaction. At 426, the identity provider 404 pushes the encrypted token and the JTI asynchronously to the token receive endpoint associated with the API key, which is an automated service endpoint associated with the automated system 402. At 428, the automated system 402 receives the encrypted token on the token receive endpoint and decrypts the token with the encryption key that was provided in the response to the token grant request at 424. The automated system 402 can associate the right encryption key by matching the JTI.

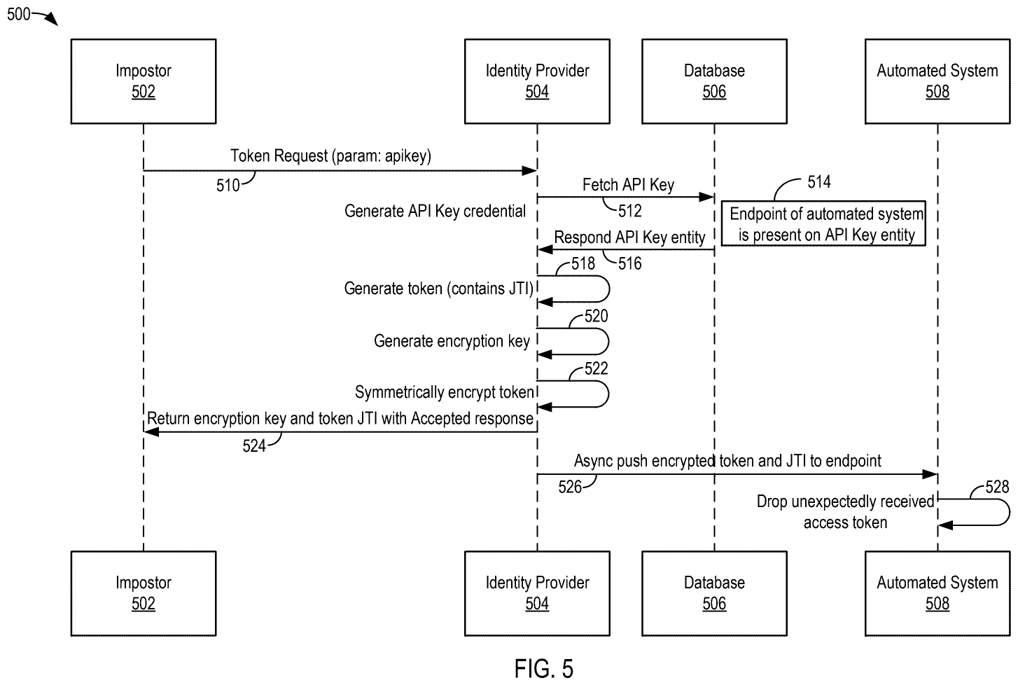

FIG. 5 sets forth interactions 500 related to preventing an impostor from acquiring access to a token in a system for secure token exchange for automated systems according to aspects of the present disclosure. In some examples, interactions 500 may be performed by system 200 (FIG. 2) using secure token exchange for automated systems code 107 (FIG. 1). In the illustrated example, the interactions 500 are between an impostor 502, an identity provider 504, a database 506, and an automated system 508. Automated system 508 is an example of automated system 202 in system 200. Identity provider 504 is an example of identity provider 204 in system 200. Database 506 is an example of storage 208 in system 200. Interactions 500 set forth an example secure API key token exchange flow that prevents impostor 502 from acquiring access to a token by using a stolen API key.

At 510 in interactions 500, impostor 502 sends an API key token grant request to identity provider 504 that includes a parameter identifying an API key (that has been stolen by the impostor 502). At 512, the identity provider 504 validates the API key and fetches the corresponding API key entity stored in its database 506. As indicated at 514, the token receive endpoint associated with the automated system 508 is present on the API key entity, which may be established during registration. At 516, the database 506 provides the API key entity to the identity provider 504. At 518, the identity provider 504 generates the authentication token, which contains a JTI claim unique to the token. At 520, the identity provider 504 generates a new encryption key. At 522, the identity provider 504 symmetrical encrypts the authentication token with the encryption key generated at 520. At 524, the identity provider 504 sends a response to the impostor 502 including the encryption key generated at 520 and the token JTI and an “accepted” indication, thereby finishing the request transaction. At 526, the identity provider 504 pushes the encrypted token and the JTI asynchronously to the token receive endpoint associated with the API key, which is an automated service endpoint associated with the automated system 508. At 528, the automated system 508 drops the unexpectedly received encrypted token since the automated system 508 did not request the token. The impostor 502 does not receive the requested token.

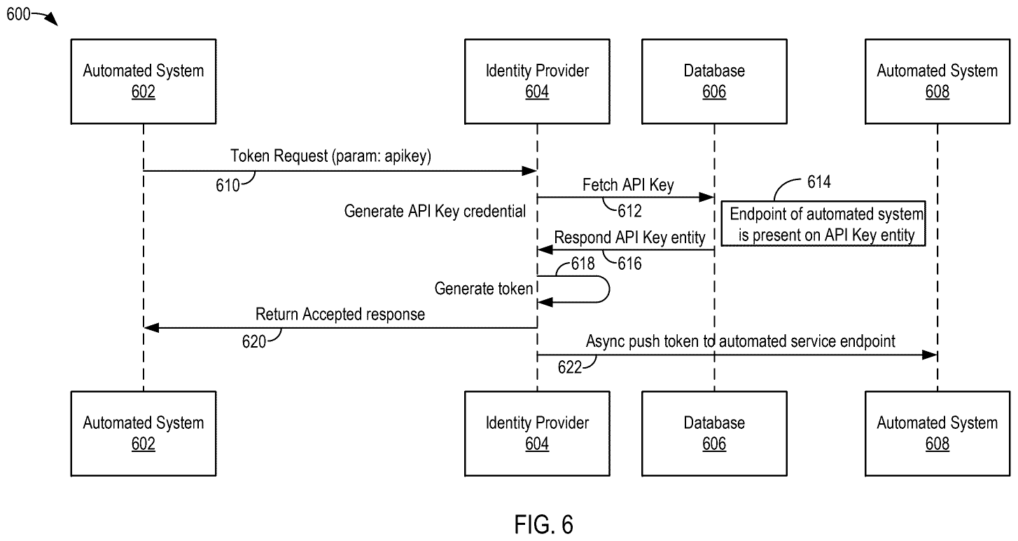

FIG. 6 sets forth interactions 600 related to secure token exchange without encryption involving two automated systems in a system for secure token exchange for automated systems according to aspects of the present disclosure. In some examples, interactions 600 may be performed by system 200 (FIG. 2) using secure token exchange for automated systems code 107 (FIG. 1). In the illustrated example, the interactions 600 are between a first automated system 602, an identity provider 604, a database 606, and a second automated system 608. First automated system 602 and second automated system 608 are examples of automated system 202 in system 200. Identity provider 604 is an example of identity provider 204 in system 200. Database 606 is an example of storage 208 in system 200. Interactions 600 set forth an example authentication including a secure API key token exchange without encryption in which the first automated system 602 that executes the API key grant is not the same as the automated system 608 that receives the token (e.g., because it is a CRON job that simply refreshes the token on the second automated system 608 before it expires).

At 610 in interactions 600, first automated system 602 sends an API key token grant request to identity provider 604 that includes a parameter identifying an API key. At 612, the identity provider 604 validates the API key and fetches the corresponding API key entity stored in its database 606. As indicated at 614, the token receive endpoint associated with the second automated system 608 is present on the API key entity, which may be established during registration. At 616, the database 606 provides the API key entity to the identity provider 604. At 618, the identity provider 604 generates the authentication token. At 620, the identity provider 604 sends a response to the first automated system 602 indicating “accepted”, thereby finishing the request transaction. At 622, the identity provider 604 pushes the encrypted token asynchronously to the token receive endpoint associated with the API key, which is an automated service endpoint associated with the second automated system 608.

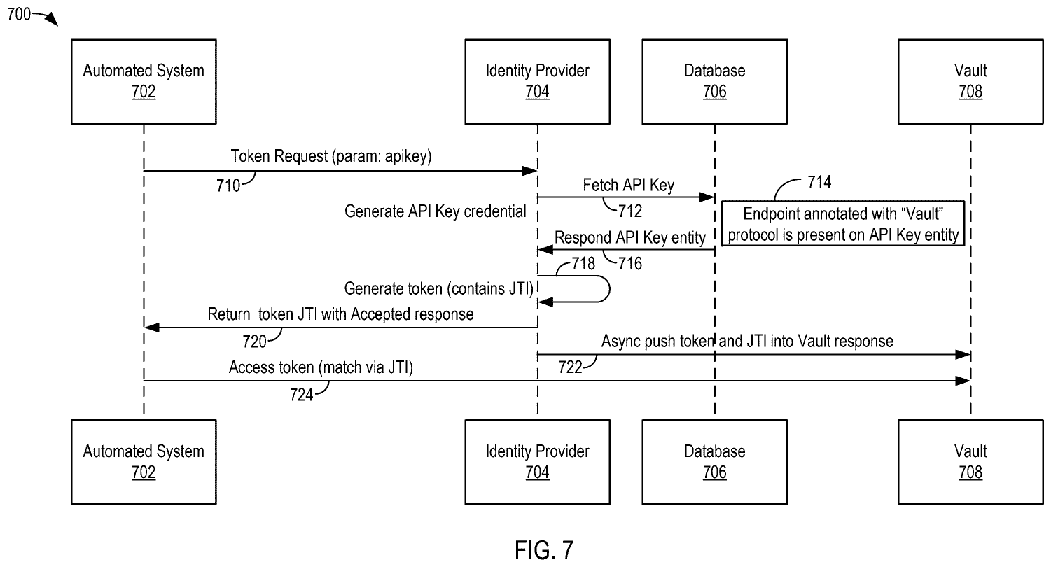

FIG. 7 sets forth interactions 700 related to secure token exchange with an annotated endpoint in a system for secure token exchange for automated systems according to aspects of the present disclosure. In some examples, interactions 700 may be performed by system 200 (FIG. 2) using secure token exchange for automated systems code 107 (FIG. 1). In the illustrated example, the interactions 700 are between automated system 702, an identity provider 704, a database 706, and a vault 708. Automated system 702 is an example of automated system 202 in system 200. Identity provider 704 is an example of identity provider 204 in system 200. Database 706 is an example of storage 208 in system 200. Interactions 700 set forth an example authentication including a secure API key token exchange in which the automated system 702 may annotate the token receive endpoint with the protocol used to push the token. An example is that the token is pushed into a vault 708 or Cloud Secrets Manager instance. If the annotation is a vault, that indicates that the token is pushed into a vault from which the automated system 702 (or another authorized component) can access the token. Although encryption is not used in the illustrated example, other examples of interactions 700 may use encryption.

At 710 in interactions 700, automated system 702 sends an API key token grant request to identity provider 704 that includes a parameter identifying an API key. At 712, the identity provider 704 validates the API key and fetches the corresponding API key entity stored in its database 706. As indicated at 714, the token receive endpoint associated with the automated system 702 is present on the API key entity and is annotated with a vault protocol, which may be established during registration. At 716, the database 706 provides the API key entity to the identity provider 704. At 718, the identity provider 704 generates the authentication token, which contains a JTI claim unique to the token. At 720, the identity provider 704 sends a response to the automated system 702 including the token JTI and an “accepted” indication, thereby finishing the request transaction. At 722, the identity provider 704 pushes the token and the JTI asynchronously according to the annotated protocol to the token receive endpoint associated with the API key, which is an endpoint associated with the vault 708. At 724, the automated system 702 accesses the token from the vault 708 by matching the JTI.

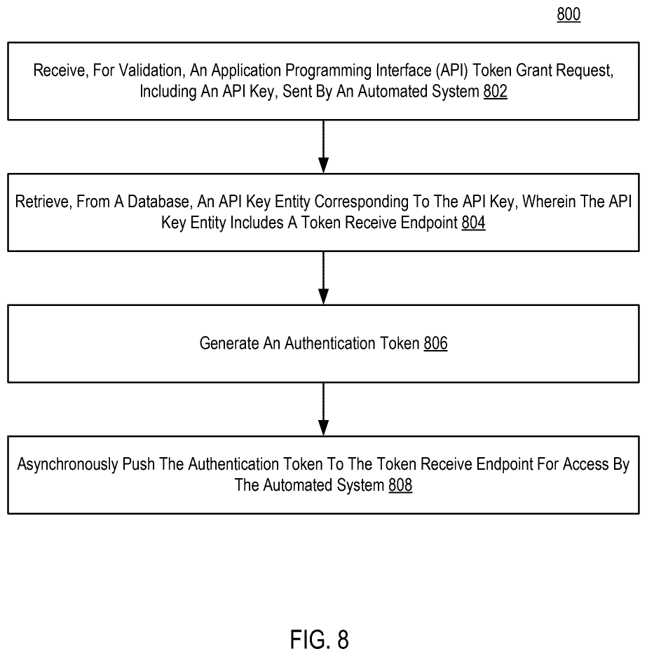

FIG. 8 sets forth a flowchart of an example method 800 for secure token exchange for automated systems according to aspects of the present disclosure. In some examples, method 800 may be performed by system 200 (FIG. 2) using secure token exchange for automated systems code 107 (FIG. 1). Method 800 comprises receiving 802, for validation, an application programming interface (API) token grant request, including an API key, sent by an automated system. Method 800 includes retrieving 804, from a database, an API key entity corresponding to the API key, wherein the API key entity includes a token receive endpoint. Method 800 includes generating 806 an authentication token. Method 800 includes asynchronously pushing 808 the authentication token to the token receive endpoint for access by the automated system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for secure token exchange for automated systems, comprising:
receiving, for validation, an application programming interface (API) token grant request, including an API key, sent by an automated system;
retrieving, from a database, an API key entity corresponding to the API key, wherein the API key entity includes a token receive endpoint;
generating an authentication token; and
asynchronously pushing the authentication token to the token receive endpoint for access by the automated system.

2. The method of claim 1, wherein the authentication token includes a unique identifier.

3. The method of claim 2, wherein the authentication token is a JavaScript Object Notation (JSON) web token (JWT), and the unique identifier is a JWT ID (JTI) claim of the JWT.

4. The method of claim 2, and further comprising:
sending a response to the automated system, wherein the response includes the unique identifier.

5. The method of claim 2, and further comprising:
generating an encryption key; and
symmetrically encrypting the authentication token with the encryption key to generate an encrypted authentication token, and wherein the authentication token that is asynchronously pushed to the token receive endpoint comprises the encrypted authentication token.

6. The method of claim 5, and further comprising:
sending a response to the automated system, wherein the response includes the unique identifier and the encryption key.

7. The method of claim 6, wherein the token receive endpoint provides access to the automated system to retrieve the encrypted authentication token and decrypt the encrypted authentication token using the encryption key included in the response.

8. The method of claim 1, wherein the token receive endpoint is annotated with a protocol for asynchronously pushing the authentication token.

9. An apparatus for secure token exchange for automated systems, comprising:
a processing device; and
memory operatively coupled to the processing device, wherein the memory stores computer program instructions that, when executed, cause the processing device to:
receive, for validation, an application programming interface (API) token grant request, including an API key, sent by an automated system;
retrieve, from a database, an API key entity corresponding to the API key, wherein the API key entity includes a token receive endpoint;
generate an authentication token; and
asynchronously push the authentication token to the token receive endpoint for access by the automated system.

10. The apparatus of claim 9, wherein the authentication token includes a unique identifier.

11. The apparatus of claim 10, wherein the memory stores computer program instructions that, when executed, further cause the processing device to:
send a response to the automated system, wherein the response includes the unique identifier.

12. The apparatus of claim 10, wherein the memory stores computer program instructions that, when executed, further cause the processing device to:
generate an encryption key; and
symmetrically encrypt the authentication token with the encryption key to generate an encrypted authentication token, and wherein the authentication token that is asynchronously pushed to the token receive endpoint comprises the encrypted authentication token.

13. The apparatus of claim 12, wherein the memory stores computer program instructions that, when executed, further cause the processing device to:
send a response to the automated system, wherein the response includes the unique identifier and the encryption key.

14. The apparatus of claim 13, wherein the token receive endpoint provides access to the automated system to retrieve the encrypted authentication token and decrypt the encrypted authentication token using the encryption key included in the response.

15. The apparatus of claim 9, wherein the token receive endpoint is annotated with a protocol for asynchronously pushing the authentication token.

16. A computer program product comprising a computer readable storage medium, wherein the computer readable storage medium comprises computer program instructions that, when executed:
receive, for validation, an application programming interface (API) token grant request, including an API key, sent by an automated system;
retrieve, from a database, an API key entity corresponding to the API key, wherein the API key entity includes a token receive endpoint;
generate an authentication token; and
asynchronously push the authentication token to the token receive endpoint for access by the automated system.

17. The computer program product of claim 16, wherein the authentication token includes a unique identifier.

18. The computer program product of claim 17, wherein the computer readable storage medium comprises computer program instructions that, when executed:
send a response to the automated system, wherein the response includes the unique identifier.

19. The computer program product of claim 17, wherein the computer readable storage medium comprises computer program instructions that, when executed:
generate an encryption key; and
symmetrically encrypt the authentication token with the encryption key to generate an encrypted authentication token, and wherein the authentication token that is asynchronously pushed to the token receive endpoint comprises the encrypted authentication token.

20. The computer program product of claim 19, wherein the computer readable storage medium comprises computer program instructions that, when executed:
send a response to the automated system, wherein the response includes the unique identifier and the encryption key.
